(19) United States
(12) Patent Application Publication
(10) Pub. No.: US 2026/0307758 A1
(43) Pub. Date: Oct. 8, 2026

(54) ELECTRONIC DERAILLEUR

(71) Applicant: TIEN HSIN INDUSTRIES CO., LTD., Taichung City (TW)

(72) Inventors: SHANG-FENG LIN, Taichung City (TW); CHANG-CHUN KAO, Taichung City (TW); RUEI-YO LIN, Taichung City (TW)

(73) Assignee: TIEN HSIN INDUSTRIES CO., LTD., Taichung City (TW)

(21) Appl. No.: 19/170,088

(22) Filed: Apr. 4, 2025

(51) Int. Cl. B62M 9/122

(52) U.S. Cl. CPC B62M 9/122

(57) ABSTRACT

An electronic derailleur includes a base portion for connecting to a frame of a bicycle, a movable portion, a first linkage, a second linkage, four pivot shafts, and a control module. The movable portion is movable relative to the base portion. Both the first linkage and the second linkage are pivotally connected to the base portion and the movable portion. The base portion, the movable portion, the first linkage, and the second linkage are pivotally connected as a four-bar linkage for moving the movable portion relative to the base portion. The pivot shafts are disposed between the base portion and the second linkage, between the second linkage and the movable portion, between the movable portion and the first linkage, and between the first linkage and the base portion, respectively. The control module is positioned relative to the base portion, the movable portion, the first linkage, or the second linkage and is disposed on one end of one of the four pivot shafts.

### BACKGROUND OF THE INVENTION

### Technical Field

The present disclosure relates generally to a rear transmission for a bicycle, and more particularly to an electronic derailleur.

### Description of Related Art

A control module of a conventional electronic derailleur is responsible for receiving a plurality of shifting signals and driving a movable portion to adjust a position of a chain. However, existing technologies generally house the control module inside a base portion of the electronic derailleur, which presents several drawbacks.

Since the control module is entirely housed within the base portion, any malfunction or component failure requires removing the entire electronic derailleur from a frame of a bicycle for repairs, increasing maintenance costs and complicating operation. Additionally, a limited space within the base portion severely restricts a size and a layout of the control module, making upgrades or replacements difficult without compromising the overall structural integrity of the electronic derailleur, thereby reducing design flexibility. Furthermore, because the control module is entirely housed within the base portion, the routing of power and signal wires becomes more complex, not only increasing assembly and maintenance difficulty but also potentially affecting wire durability and signal stability.

Therefore, how to provide an electronic derailleur that optimizes the configuration of the control module to enhance maintenance convenience and structural flexibility remains an urgent issue to be addressed.

### BRIEF SUMMARY OF THE INVENTION

In view of the above, the primary objective of the present disclosure is to provide an electronic derailleur that enhances the configuration of a control module.

The present disclosure provides an electronic derailleur that is mounted on a frame of a bicycle and includes a base portion, a movable portion, a first linkage, a second linkage, four pivot shafts, and a control module. The base portion is configured to connect to the frame of the bicycle. The movable portion is movable relative to the base portion. The first linkage is pivotally connected to the base portion and the movable portion. The second linkage is pivotally connected to the base portion and the movable portion, wherein the base portion, the movable portion, the first linkage, and the second linkage are pivotally connected as a four-bar linkage for moving the movable portion relative to the base portion. The pivot shafts are located between the base portion and the second linkage, between the second linkage and the movable portion, between the movable portion and the first linkage, and between the first linkage and the base portion, respectively. The control module is positioned relative to the base portion, the movable portion, the first linkage, or the second linkage, wherein the control module is disposed on one end of one of the four pivot shafts.

The advantage of the present disclosure is that the control module is positioned relative to the base portion, the movable portion, the first linkage, or the second linkage, and is disposed on the end of one of the four pivot shafts. In this way, the configuration not only ensures the stability of the control module during the operation of the electronic derailleur but also effectively reduces the risk of performance degradation of the control module due to vibration or external forces. Furthermore, the configuration helps optimize the spatial utilization of the overall structure of the electronic derailleur, improving durability and reliability of the electronic derailleur, and further enhancing the operational efficiency and precision of the shifting system.

### BRIEF DESCRIPTION OF THE SEVERAL VIEWS OF THE DRAWINGS

The present disclosure will be better understood by referring to the following detailed description of some illustrative embodiments in conjunction with the accompanying drawings, in which

FIG. 1 is a perspective view of an electronic derailleur of an embodiment of the present disclosure;

FIG. 2 is a top view of the electronic derailleur of the embodiment;

FIG. 3 is a perspective view of the electronic derailleur of the embodiment from another perspective;

FIG. 4 is a perspective view of the electronic derailleur of the embodiment from another perspective;

FIG. 5 is a partially exploded view of the electronic derailleur of the embodiment;

FIG. 6 is another partially exploded view of the electronic derailleur of the embodiment;

FIG. 7 is an enlarged schematic view of a marked region B in FIG. 3;

FIG. 8 is an enlarged schematic view of a marked region C in FIG. 4, wherein the casing is presented in dashed lines to show components inside the casing of the control module;

FIG. 9 is a sectional view in the A-A line in FIG. 2; and

FIG. 10 is an enlarged schematic view of a marked region D in FIG. 9.

### DETAILED DESCRIPTION OF THE INVENTION

In the description of a plurality of embodiments of the present disclosure, terms such as “above” and other directional or positional descriptions are used based on the orientation or positional relationships shown in a plurality of drawings. These terms are used for convenience in describing the present disclosure and do not limit the present disclosure, nor do they indicate or suggest that the mentioned components must have a specific orientation or be constructed in a specific direction. Furthermore, the terms “first,” “second,” and similar terms used in this specification or the claims are merely for naming elements or distinguishing between different embodiments or scopes, and are not intended to limit the number of elements to a specific upper or lower limit.

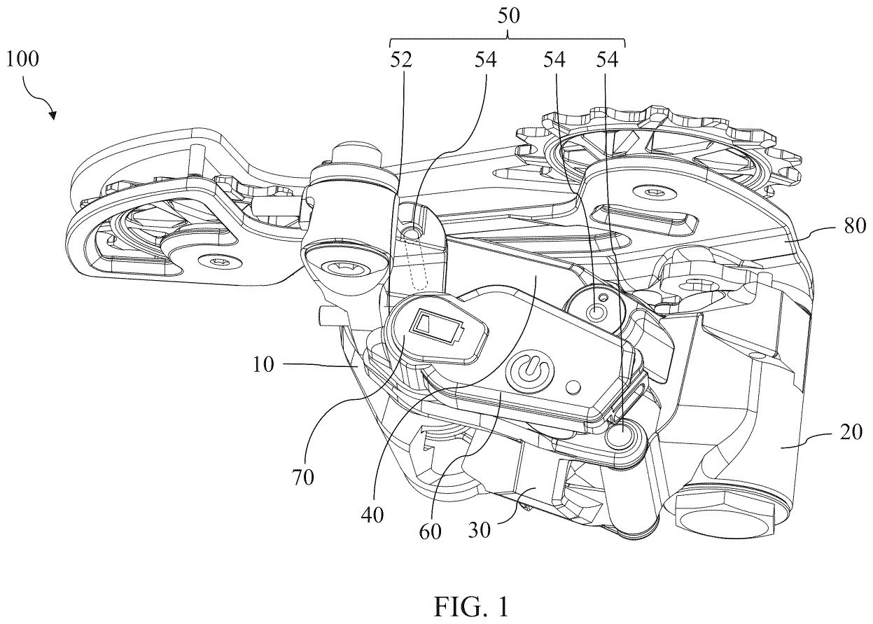

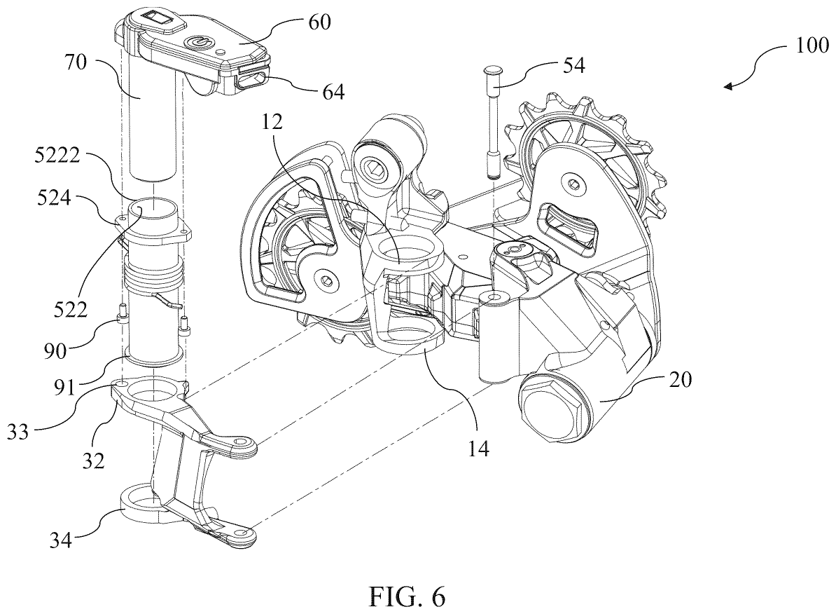

Referring to FIG. 1 and FIG. 6, an electronic derailleur 100 of an embodiment of the present disclosure is mounted on a frame of a bicycle (not shown). The electronic derailleur 100 includes a base portion 10, a movable portion 20, a first linkage 30, a second linkage 40, four pivot shafts 50, a control module 60, a battery assembly 70, a chain guide portion 80, and a plurality of positioning members 90.

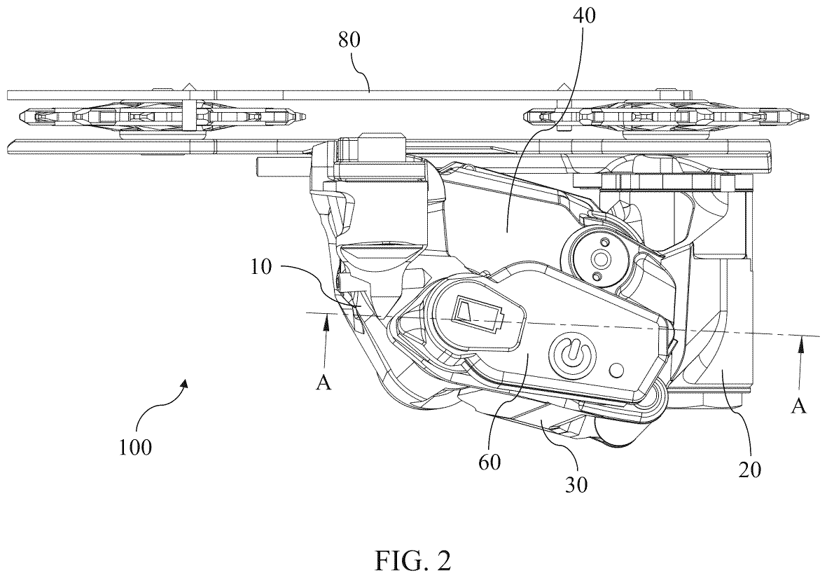

Referring to FIG. 1 and FIG. 2, the base portion 10, the movable portion 20, the first linkage 30, and the second linkage 40 are pivotally connected as a four-bar linkage. One end of the base portion 10 is adapted to connect to the frame of the bicycle to provide a stable mounting point for the electronic derailleur 100. The movable portion 20 is movable relative to the base portion 10 to achieve a speed-changing function. Two ends of the first linkage 30 are pivotally connected to the base portion 10 and the movable portion 20 respectively, and two ends of the second linkage 40 are pivotally connected to the base portion 10 and the movable portion 20 respectively, so that the movable portion 20 is movable relative to the base portion 10. The second linkage 40 is closer to the frame than the first linkage 30.

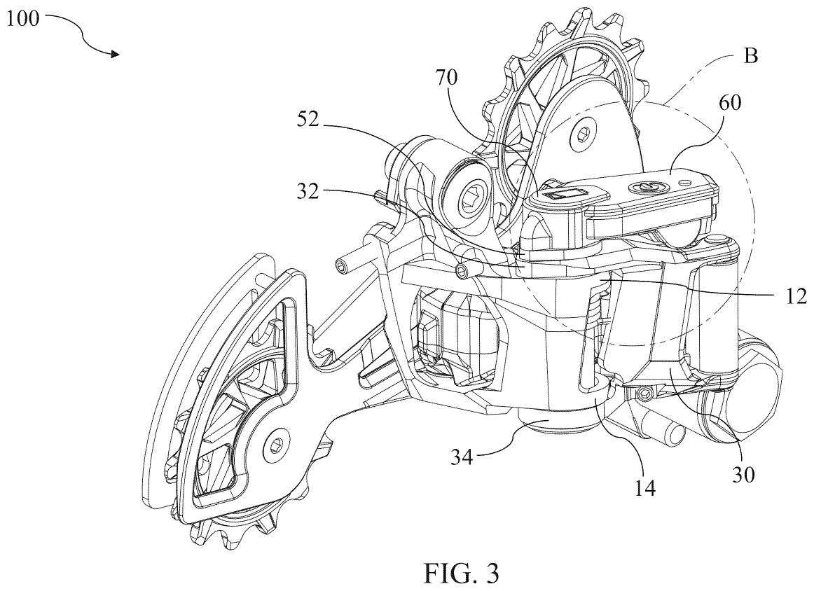

As shown in FIG. 3, the base portion 10 has a first pivoting ring 12 and a second pivoting ring 14. The first pivoting ring 12 and the second pivoting ring 14 are disposed coaxially at one end of the base portion 10 adjacent to the first linkage 30, and the first pivoting ring 12 is located above the second pivoting ring 14.

As shown in FIG. 3, the first linkage 30 has a third pivoting ring 32 and a fourth pivoting ring 34. The third pivoting ring 32 and the fourth pivoting ring 34 are disposed coaxially at one end of the first linkage 30 adjacent to the base portion 10, and the third pivoting ring 32 is located above the fourth pivoting ring 34. The third pivoting ring 32 is disposed above the first pivoting ring 12, and the second pivoting ring 14 is disposed above the fourth pivoting ring 34.

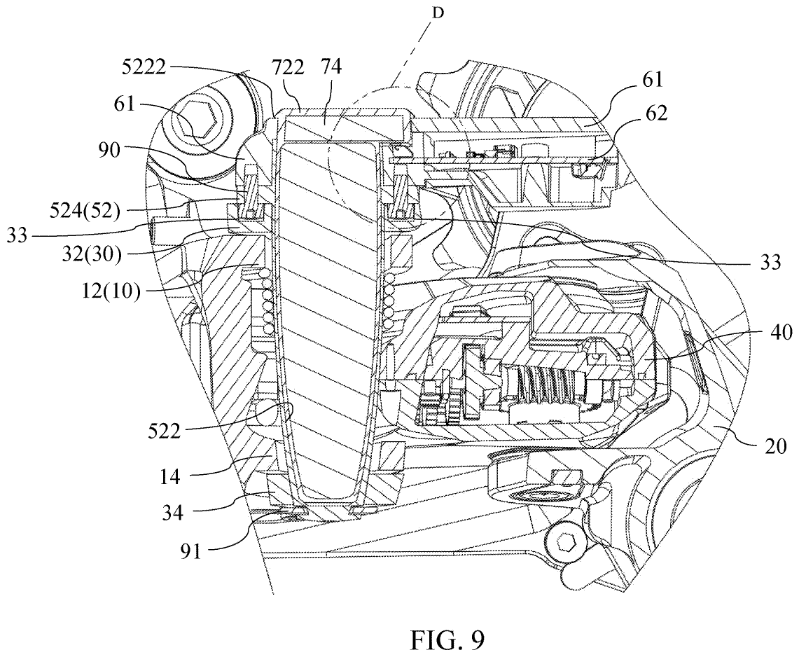

As shown in FIG. 6 and FIG. 9, a plurality of positioning holes 33 are provided on the third pivoting ring 32 for corresponding positioning of the positioning members 90.

As shown in FIG. 1, the four pivot shafts 50 are located between the base portion 10 and the second linkage 40, between the second linkage 40 and the movable portion 20, between the movable portion 20 and the first linkage 30, and between the first linkage 30 and the base portion 10, respectively. In this way, the pivot shafts 50 could provide rotational support between the linkages to ensure the stability and flexibility in motion of the overall mechanism.

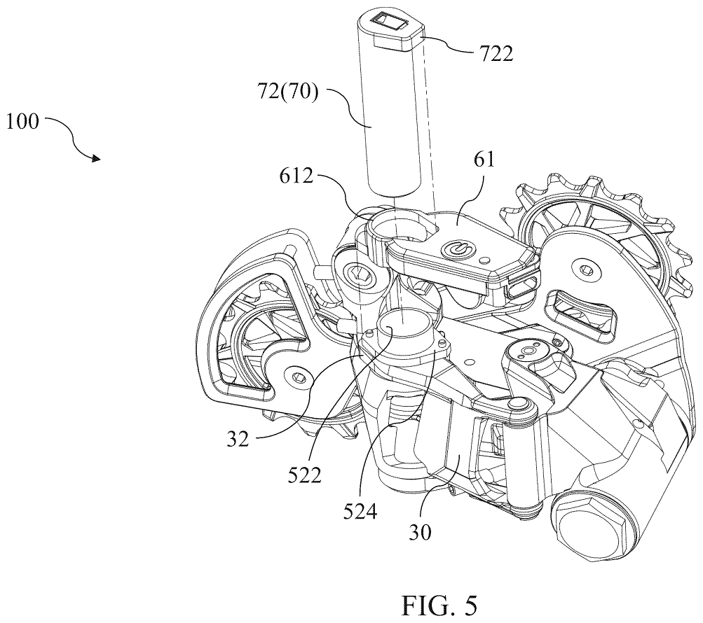

As shown in FIG. 1, FIG. 5, FIG. 6, and FIG. 9, the pivot shafts 50 are a first pivot shaft 52 and three second pivot shafts 54. The first pivot shaft 52 is defined as a tubular structure having a battery cavity 522. Each second pivot shaft 54 is defined as a rod-shaped structure.

As shown in FIG. 3 and FIG. 9, the first pivot shaft 52 is located between the first linkage 30 and the base portion 10, and the first pivot shaft 52 is disposed in the first pivoting ring 12, the second pivoting ring 14, the third pivoting ring 32, and the fourth pivoting ring 34, thereby providing support and a rotation function between the first linkage 30 and the base portion 10.

In the current embodiment, the first pivot shaft 52 is located between the first linkage 30 and the base portion 10. In other embodiments, the first pivot shaft 52 could also be located between the base portion 10 and the second linkage 40, between the second linkage 40 and the movable portion 20, or between the movable portion 20 and the first linkage 30 to meet different mechanism needs.

As shown in FIG. 6 and FIG. 9, the first pivot shaft 52 includes the battery cavity 522, and one end of the first pivot shaft 52 has a positioning portion 524. The battery cavity 522 is formed inside the first pivot shaft 52, and the battery cavity 522 has an opening 5222 for housing the battery assembly 70. Through the design of the first pivot shaft 52, the effective integration of the battery assembly 70 is achieved, thereby simplifying the mechanical structure, improving space utilization, and effectively reducing the impact of external collisions on the battery assembly 70.

As shown in FIG. 6 to FIG. 9, the positioning portion 524 is adapted to secure the positioning members 90. The positioning portion 524 is a protruding ring disposed on an outer surface of the first pivot shaft 52, and the positioning portion 524 is disposed above the third pivoting ring 32.

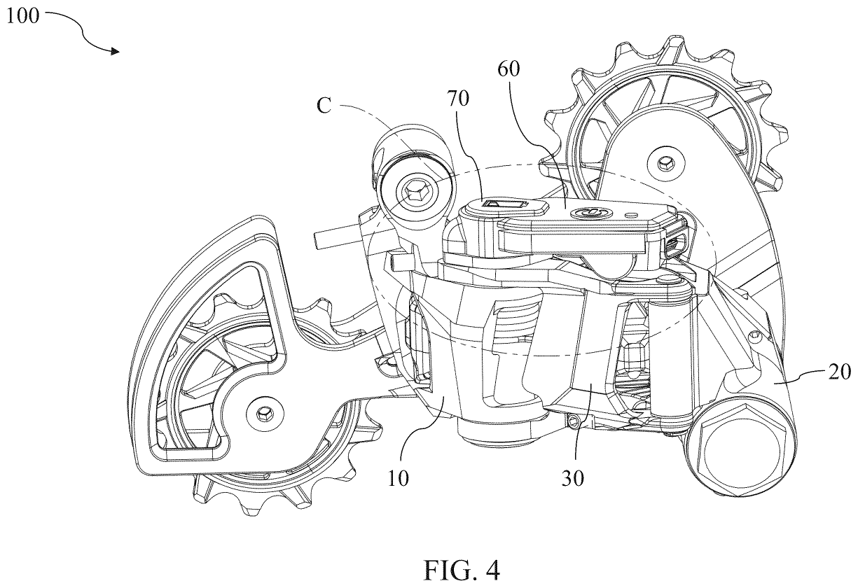

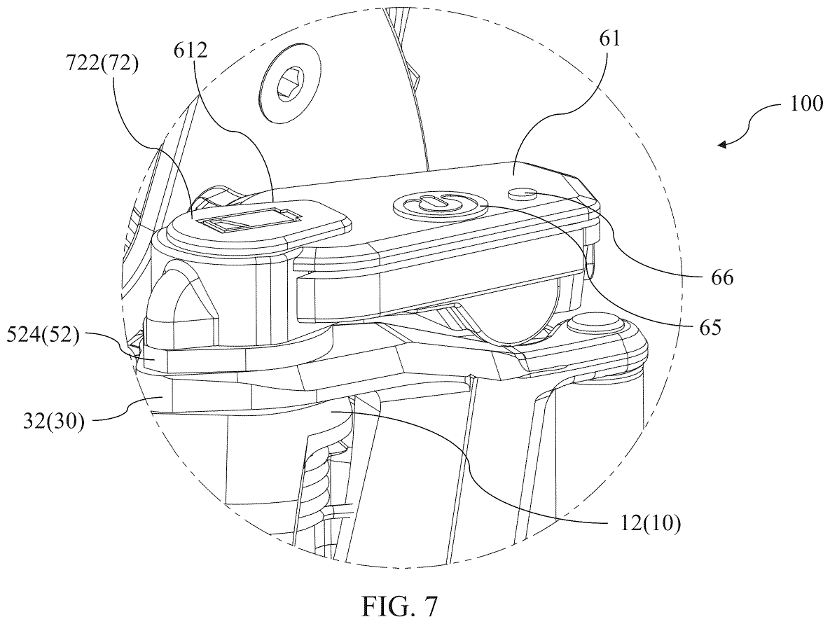

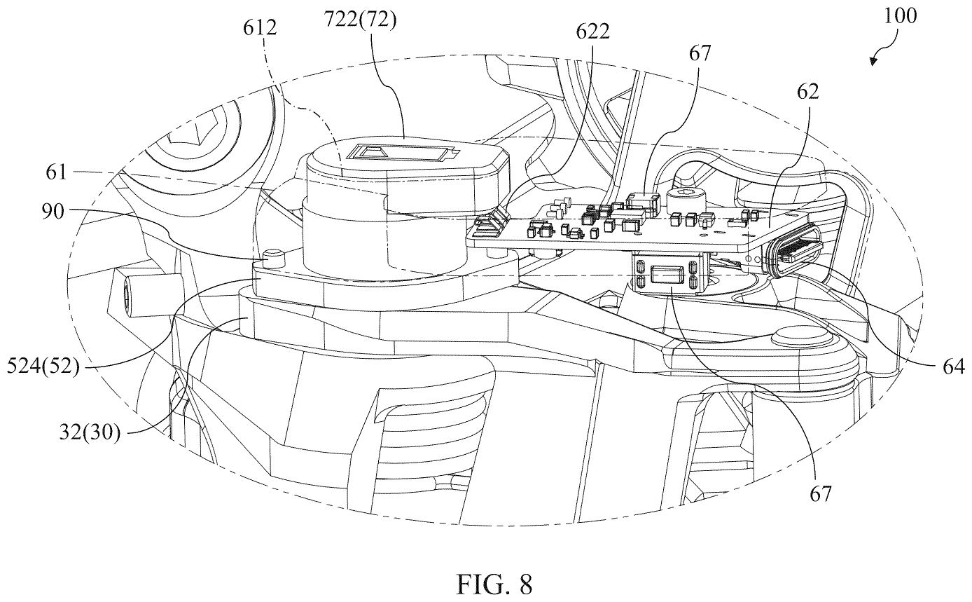

As shown in FIG. 4, FIG. 7, and FIG. 8, the control module 60 includes a casing 61, a circuit board 62, a connector 64, a switch 65, a visual indicator 66, and an antenna 67.

As shown in FIG. 4, FIG. 7, and FIG. 8, the casing 61 extends along an extension direction of the first linkage 30. One end of the casing 61 is disposed above the positioning portion 524 of the first pivot shaft 52. The end of the casing 61 has a through hole 612, wherein an end cap 722 of the battery assembly 70 is secured in the through hole 612. In this way, the control module 60 and the battery assembly 70 are fixed to each other.

As shown in FIG. 8, the casing 61 encases the circuit board 62, and one end of the circuit board 62 is provided with a contact 622 for being electrically connected to the battery assembly 70. Since the circuit board 62 is located at one end of the battery assembly 70, a current conduction path is shortened, thereby effectively reducing current loss and further enhancing electrical energy transmission efficiency and overall system performance.

As shown in FIG. 8, one end of the connector 64 is electrically connected to one end of the circuit board 62 away from the contact 622, and another end of the connector 64 passes through the casing 61 to be exposed outward for transmission and data communication. Since the connector 64 is located adjacent to the battery assembly 70, a current transmission distance is effectively shortened, thereby reducing current loss and further enhancing charging efficiency and system performance.

In the current embodiment, the casing 61 is made of a non-metallic material, such as plastic, to reduce electrical conductivity and mitigate the risk of short circuits. Additionally, the non-metallic material offers superior insulation, corrosion resistance, and signal permeability, contributing to the durability and safety of the control module 60 while preventing wireless signals from being shielded or attenuated by the casing 61.

As shown in FIG. 7, the switch 65 is disposed on the casing 61. The switch 65 is electrically connected to the circuit board 62 for controlling an operation of the circuit board 62. Specifically, the switch 65 is a power switch configured to control the power on and off of the circuit board 62, thereby enabling power management of the control module 60.

In the current embodiment, the switch 65 is a push-button switch. In other embodiments, the switch 65 could also be a touch switch.

In the current embodiment, the switch 65 is the power switch. In other embodiments, the switch 65 could also be a mode control switch configured to switch between a plurality of operating modes of the circuit board 62; for example, the switch 65 could select different operating parameters or function settings to accommodate various application needs.

In the current embodiment, the number of the switch 65 is one. In other embodiments, the number of the switch 65 could also be two, wherein the two switches are the power switch and the mode control switch, respectively.

As shown in FIG. 7, the visual indicator 66 is disposed on the casing 61. The visual indicator 66 is electrically connected to the circuit board 62. The visual indicator 66 is configured to display at least one of the following: a plurality of battery levels of the battery assembly 70, a plurality of gear statuses, a plurality of operating statuses, a plurality of error messages, and a plurality of operation modes. In this way, a user could quickly assess the information about the electronic derailleur 100, enhancing operational convenience and user experience.

Specifically, the visual indicator 66 displays the information about the electronic derailleur 100 through changes in light color, flashing speed, frequency, and intervals. For example:

To display the battery levels of the battery assembly 70, a green light indicates sufficient power, a yellow light indicates low power, and a red light indicates very low power requiring charging.

To display the gear statuses, different colors or flashing patterns indicate the position of the electronic derailleur 100. For instance, the highest and lowest gears could be indicated with a specific color or rapid flashing.

To display the operating statuses, a brief green flash indicates a successful gear shift, a red flash indicates a failed shift, and an intermittent flash indicates fine-tuning mode.

To display the error messages, a rapid red flash indicates a system anomaly or limited operation, while a continuous red light indicates a startup error.

To display the operation modes, a blue light indicates normal mode, a green light indicates power-saving mode, a yellow light indicates standby mode, and a slow red flash indicates charging mode.

As shown in FIG. 8, the antenna 67 is electrically connected to the circuit board 62 to receive an external wireless signal and transmit the external wireless signal to the circuit board 62, as well as to transmit an internal wireless signal from the circuit board 62 to an external device. Through the antenna 67, bidirectional wireless communication between the electronic derailleur 100 and the external device could be achieved, such as receiving a plurality of remote control commands or sending status information of the electronic derailleur 100, thereby enhancing the intelligence and operational convenience of the electronic derailleur 100.

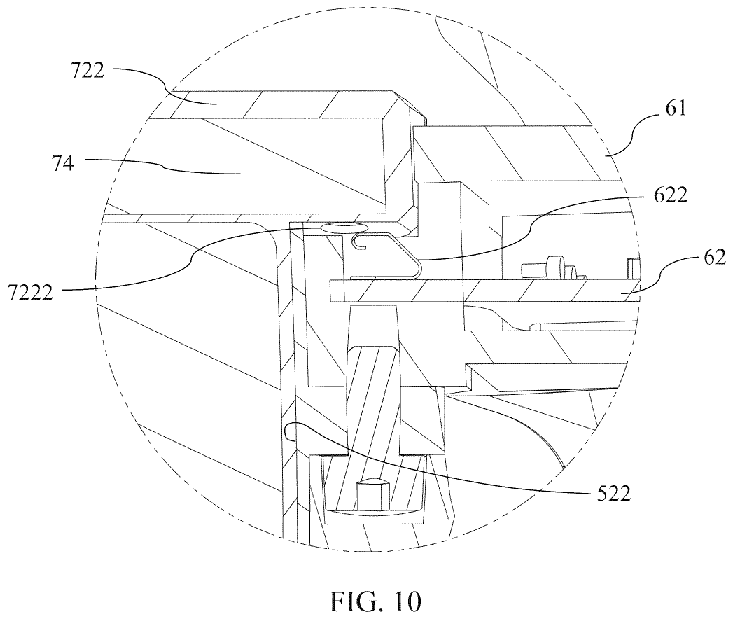

As shown in FIG. 8 and FIG. 9, the battery assembly 70 includes a battery housing 72 and a battery unit 74. The battery housing 72 is disposed in the battery cavity 522 of the first pivot shaft 52. The battery unit 74 is disposed in the battery housing 72. As shown in FIG. 7 to FIG. 9, one end of the battery housing 72 has the end cap 722 protruding from the opening 5222 of the battery cavity 522. As shown in FIG. 10, the end cap 722 has a terminal opening 7222 disposed on a bottom surface of the end cap 722 for a terminal (not shown) of the battery unit 74 to be exposed outward. The terminal is electrically connected to the contact 622 of the circuit board 62. In this way, the secure protection for the battery unit 74 could be provided, the stable connection between the battery unit 74 and the circuit board 62 could be ensured, and convenient operation could be achieved.

As shown in FIG. 1 and FIG. 2, the chain guide portion 80 is pivotally connected to the movable portion 20 and is movable relative to the base portion 10 along with the movable portion 20. Since the movable portion 20 and the chain guide portion 80 are movable relative to the base portion 10, a chain of the bicycle (not shown) could be moved from one sprocket (not shown) to another sprocket (not shown), thereby achieving a smooth speed-changing function.

As shown in FIG. 6, FIG. 8, and FIG. 9, the positioning members 90 are disposed around the battery assembly 70. In the current embodiment, one end of each positioning member 90 is disposed in each positioning hole 33 of the third pivoting ring 32, and another end of each positioning member 90 passes sequentially through the positioning portion 524 of the first pivot shaft 52, and the casing 61 of the control module 60. In this way, the positioning portion 524 of the first pivot shaft 52, the third pivoting ring 32 of the first linkage 30, and the casing 61 of the control module 60 are positioned relative to each other, and the first pivot shaft 52 and the casing 61 of the control module 60 are fixed to each other.

Moreover, by keeping the control module 60 in a fixed position relative to the first linkage 30 and extending the casing 61 of the control module 60 along the extension direction of the first linkage 30, the control module 60 of the electronic derailleur 100 is protected from external impacts during use. This structural design not only enhances overall stability but also effectively reduces the risk of performance degradation caused by vibrations or impacts, further improving the durability and reliability of the control module 60.

In the current embodiment, the number of the positioning members 90 is two, and the number of the positioning holes 33 of the third pivoting ring 32 is also two. In other embodiments, the number of the positioning members 90 could also be one or plural, and the number of positioning holes 33 could correspondingly be one or plural, ensuring structural stability and accommodating different installation requirements.

In the current embodiment, the first pivot shaft 52 and the casing 61 of the control module 60 are fixed to each other. The first pivot shaft 52 is located between the first linkage 30 and the base portion 10. The control module 60 is positioned relative to the first linkage 30, and the casing 61 extends along the extension direction of the first linkage 30. In other embodiments, if the first pivot shaft 52 and the casing 61 of the control module 60 are fixed to each other, and the first pivot shaft 52 is located between the base portion 10 and the second linkage 40, between the second linkage 40 and the movable portion 20, or between the movable portion 20 and the first linkage 30, the control module 60 could also be positioned relative to the base portion 10, the movable portion 20, or the second linkage 40. Moreover, in other embodiments, if the first pivot shaft 52 is located between the base portion 10 and the second linkage 40, or between the second linkage 40 and the movable portion 20, the casing 61 could also extend along an extension direction of the second linkage 40.

As shown in FIG. 6 and FIG. 9, in the current embodiment, the first pivot shaft 52 has a stop member 91. The stop member 91 is engaged with an outer side of the first pivot shaft 52 and located on a bottom side of the fourth pivoting ring 34 of the first linkage 30. The stop member 91 is configured to limit a displacement of the first pivot shaft 52 relative to the fourth pivoting ring 34. By the stop member 91 working with the positioning portion 524, the first pivot shaft 52 is prevented from being displaced in a longitudinal direction of the first pivot shaft 52 relative to the base portion 10 and the first linkage 30, thereby enabling the base portion 10 to be pivotally connected to the first linkage 30 through the first pivot shaft 52 more securely. In other embodiments, a position of the stop member 91 could be adjustable in the longitudinal direction of the first pivot shaft 52; the stop member 91 could be disposed on a bottom side of the first pivoting ring 12, a bottom side of the second pivoting ring 14, or a bottom side of the third pivoting ring 32 to limit a displacement of the first pivot shaft 52 relative to the first pivoting ring 12, the second pivoting ring 14, or the third pivoting ring 32. Through the stop member 91 working with the positioning portion 524, the first pivot shaft 52 could also be prevented from being displaced in the longitudinal direction of the first pivot shaft 52 relative to the base portion 10 and the first linkage 30, which further ensures the stability of the overall structure.

In summary, the electronic derailleur 100 of the present disclosure discloses that the control module 60 is positioned relative to the base portion 10, the movable portion 20, the first linkage 30, or the second linkage 40, and is disposed on the end of the first pivot shaft 52. In this way, the configuration not only ensures the stability of the control module 60 during the operation of the electronic derailleur 100 but also effectively reduces the risk of performance degradation of the control module 60 due to vibration or external forces. Furthermore, the configuration helps optimize the spatial utilization of the overall structure of the electronic derailleur 100, improving durability and reliability of the electronic derailleur 100, and further enhancing the operational efficiency and precision of the shifting system.

It must be pointed out that the embodiments described above are only some preferred embodiments of the present disclosure. All equivalent structures which employ the concepts disclosed in this specification and the appended claims should fall within the scope of the present disclosure.

1. An electronic derailleur, comprising:
a base portion;
a movable portion, movable relative to the base portion;
a first linkage, pivotally connected to the base portion and the movable portion;
a second linkage, pivotally connected to the base portion and the movable portion, wherein the base portion, the movable portion, the first linkage, and the second linkage are pivotally connected as a four-bar linkage for moving the movable portion relative to the base portion;
four pivot shafts, located between the base portion and the second linkage, between the second linkage and the movable portion, between the movable portion and the first linkage, and between the first linkage and the base portion, respectively; and
a control module, positioned relative to the base portion, the movable portion, the first linkage, or the second linkage, wherein the control module is disposed on one end of one of the four pivot shafts.

2. The electronic derailleur as claimed in claim 1, wherein the pivot shafts are a first pivot shaft and three second pivot shafts; the control module is positioned relative to the first linkage or the second linkage, wherein the control module is disposed on one end of the first pivot shaft; the control module extends along an extension direction of the first linkage or the second linkage, which is positioned relative to the control module.

3. The electronic derailleur as claimed in claim 2, wherein the control module is positioned relative to the first linkage; the control module comprises a casing extending along the extension direction of the first linkage; the first pivot shaft is located between the first linkage and the base portion.

4. The electronic derailleur as claimed in claim 3, wherein the control module comprises a circuit board and a connector; the casing encases the circuit board; one end of the connector is connected to the circuit board, and another end of the connector passes through the casing to be exposed outward for transmission and data communication.

5. The electronic derailleur as claimed in claim 4, wherein the control module comprises at least one switch disposed on the casing; the at least one switch is electrically connected to the circuit board for controlling an operation of the circuit board.

6. The electronic derailleur as claimed in claim 5, wherein the number of the at least one switch is two; the two switches are a power switch and a mode control switch, respectively; the power switch is configured to control the power on and off of the circuit board, and the mode control switch is configured to switch between a plurality of operating modes of the circuit board.

7. The electronic derailleur as claimed in claim 4, further comprising a battery assembly electrically connected to the control module, wherein the battery assembly comprises a battery housing; the first pivot shaft comprises a battery cavity for housing the battery assembly; one end of the battery housing has an end cap protruding from an opening of the battery cavity; the casing of the control module has a through hole, wherein the end cap of the battery housing is secured in the through hole.

8. The electronic derailleur as claimed in claim 3, further comprising at least one positioning member; the end of the first pivot shaft has a positioning portion adapted to secure the at least one positioning member; the at least one positioning member is adapted to fix the first pivot shaft and the casing of the control module to each other.

9. The electronic derailleur as claimed in claim 8, wherein one end of the first linkage adjacent to the base portion has a third pivoting ring; at least one positioning hole is provided on the third pivoting ring; the at least one positioning member is correspondingly disposed in the at least one positioning hole; the at least one positioning member is adapted to position the third pivoting ring of the first linkage, the positioning portion of the first pivot shaft, and the casing of the control module relative to each other.

10. The electronic derailleur as claimed in claim 7, wherein the control module comprises a visual indicator disposed on the casing and electrically connected to the circuit board;
the visual indicator is configured to display at least one of the following: a plurality of battery levels of the battery assembly, a plurality of gear statuses, a plurality of operating statuses, a plurality of error messages, and a plurality of operation modes.

11. The electronic derailleur as claimed in claim 4, wherein the control module comprises an antenna; the antenna is electrically connected to the circuit board to receive an external wireless signal and transmit the external wireless signal to the circuit board, as well as to transmit an internal wireless signal from the circuit board to an external device.

12. The electronic derailleur as claimed in claim 1, wherein the control module comprises a casing; the casing is made of a non-metallic material.
